(19) United States
(12) Patent Application Publication
(10) Pub. No.: US 2018/0003498 A1
(43) Pub. Date: Jan. 4, 2018

(54) VISUAL POSITIONING SYSTEM AND METHOD BASED ON HIGH REFLECTIVE INFRARED IDENTIFICATION

(71) Applicant: BEIJING ANTVR TECHNOLOGY CO., LTD., Beijing (CN)

(72) Inventor: Zheng QIN, Beijing (CN)

(21) Appl. No.: 15/707,094

(22) Filed: Sep. 18, 2017

Related U.S. Application Data
(63) Continuation of application No. PCT/CN2016/077467, filed on Mar. 28, 2016.

(30) Foreign Application Priority Data
Apr. 16, 2015 (CN) 201510181372.3

(51) Int. Cl. G01C 11/28; G06T 7/73

(52) U.S. Cl. CPC G01C 11/28; G06T 7/73; G06T 2207/10048

(57) ABSTRACT

A visual positioning system based on highly infrared-reflective identification, including a plurality of identification points (102), an infrared photographing device (101) and an image processing unit (103). The plurality of identification points (102) is passive identification points made of a highly infrared-reflective material and are arranged at equal intervals in a plane to be positioned; the infrared photographing device (101) is used for shooting a reflective image of the identification points (102); and the image processing unit (103) obtains a relative position and relative attitude variation by acquiring and analyzing information about an image shot by an infrared camera (101a). Also provided is a visual positioning method based on highly infrared-reflective identification. The visual positioning system and method have the advantages of simple structure, no need of power supply, low costs, no delay and high positioning precision.

### CROSS-REFERENCE TO RELATED APPLICATION

This application is a continuation application of International Patent Application No. PCT/CN2016/077467, filed on Mar. 28, 2016, which itself claims priority to Chinese Patent Application No. 201510181372.3, filed on Apr. 16, 2015 in the State Intellectual Property Office of P.R. China, which are hereby incorporated herein in their entireties by reference.

### FIELD OF THE INVENTION

The present invention relates to a visual positioning system and method, and more particularly to a visual positioning system based on highly infrared-reflective identification and method.

### BACKGROUND OF THE INVENTION

Generally, in the field of computer vision, especially the field of virtual reality, an image of an identification point in an environment is by processed and analyzed, and coordinate information and attitude information of an image capture device (such as a camera) are determined.

Currently, commonly used identification points are active identification points. Such active identification points all have coordinate information allocated thereto and need to include therein a signal transmitter and other modules. Positioning in a large space requires a large number of such active identification points. In addition, there are also disadvantages such as complex structure, proneness to faults, inconvenience in deployment, and positioning delay.

In view of the above-mentioned deficiencies in the prior art, it is necessary to develop a visual positioning system and method based on passive identification that feature a simple structure, convenience in deployment, and real-time positioning.

### SUMMARY OF THE INVENTION

An objective of the present invention is to provide a visual positioning system based on highly infrared-reflective identification, including a plurality of identification points, an infrared photographing device, and an image processing unit, wherein

the plurality of identification points is passive identification points made of a highly infrared-reflective material, and the identification points are arranged at equal intervals on a plane that needs to be positioned;

the infrared photographing device includes an infrared camera and an infrared light source and is configured to shoot a reflective image of the plurality of identification points, wherein an irradiation range of the infrared light source should cover a shooting area of the infrared camera; and

the image processing unit continuously obtains a positional relationship between at least three identification points that are not on a same straight line in an image shot by the infrared camera, and further compares a positional relationship between neighboring identification points to obtain continuous changes in a relative position and a relative attitude of the infrared camera.

Preferably, the plurality of identification points is made of a metal powder.

Preferably, the plurality of identification points is each an adhesive or meltable sheet structure.

Preferably, the infrared camera is a wide-angle camera.

Preferably, the number of the infrared cameras is one or two.

Preferably, the plurality of identification points is laid at intersections of four sides of a floor tile.

Preferably, a dimension of the floor tile is calculated by the image processing unit according to a shooting height and a movement speed of the infrared camera.

Preferably, the positional relationship between the identification points includes a distance between the identification points, an angle between lines connecting the identification points, and an area surrounded by the lines.

Preferably, the visual positioning system further includes a plurality of active signal points and a signal receiver located in the infrared photographing device, wherein the signal receiver is configured to receive absolute positioning information sent from the active signal points.

The present invention further provides a visual positioning method based on highly infrared-reflective identification, for determining a relative displacement and attitude of a moving target, wherein the moving target moves in an environment where a plurality of passive infrared identification points is disposed, and the moving target is equipped with an infrared camera configured to photograph the infrared identification points under irradiation of an infrared light source, the method including the following steps:

a) shooting, by the infrared camera equipped in the moving target, a first image including the infrared identification points, and recording a first shooting time;

b) determining whether a number of infrared identification points in the first image is at least three and the infrared identification points are not on a same straight line; if yes, selecting one or more groups of at least three points that are not on a same straight line and constructing a first family polygon, and performing step c); otherwise, returning to the step a);

c) after a first time interval, shooting, by the infrared camera equipped in the moving target, a second image including the infrared identification points, and recording a second shooting time;

d) determining whether a number of infrared identification points in the second image is at least three and the infrared identification points are not on a same straight line; if yes, selecting one or more groups of at least three points that are not on a same straight line and constructing a first family polygon, and performing step e); otherwise, returning to the step c); and

e) calculating a relative displacement and/or shape change between the first family polygon and the second family polygon, and obtaining a relative displacement and attitude of the moving target at the second shooting time relative to the first shooting time.

The visual positioning system based on highly infrared-reflective identification and method of the present invention can obtain attitude information of the user while implementing positioning. The identification points made of a highly infrared-reflective material have the advantages of simple structure, no need for a power supply, convenience in use, low costs, and no delay, etc.

It should be understood that the above general description and the following detailed description are both provided for exemplary and explanatory purposes, and should not be construed as limiting the scope of protection of the present invention.

### BRIEF DESCRIPTION OF THE DRAWINGS

Further objectives, effects, and advantages of the present invention will become apparent from the following description of the embodiments of the present invention with reference to the accompanying drawings, wherein:

FIG. 1 schematically illustrates a schematic application diagram of a visual positioning system according to the present invention;

FIG. 2 schematically illustrates a system block diagram of a visual positioning system according to the present invention; and

FIG. 3A, FIG. 3B, FIG. 4A and FIG. 4B schematically illustrate diagrams of image processing and analysis in a visual positioning method according to the present invention.

### DETAILED DESCRIPTION OF THE INVENTION

The objectives and functions of the present invention and the method for achieving these objectives and functions will be described in detail with reference to exemplary embodiments. However, the present invention is not limited to the exemplary embodiments disclosed below, but may be implemented in different forms. The essence of this specification is merely for the purpose of helping those skilled in the art to have a comprehensive understanding of the details of the present invention.

The embodiments of the present invention will be described below with reference to the accompanying drawings. In the accompanying drawings, same reference numerals represent same or similar parts or same or similar steps.

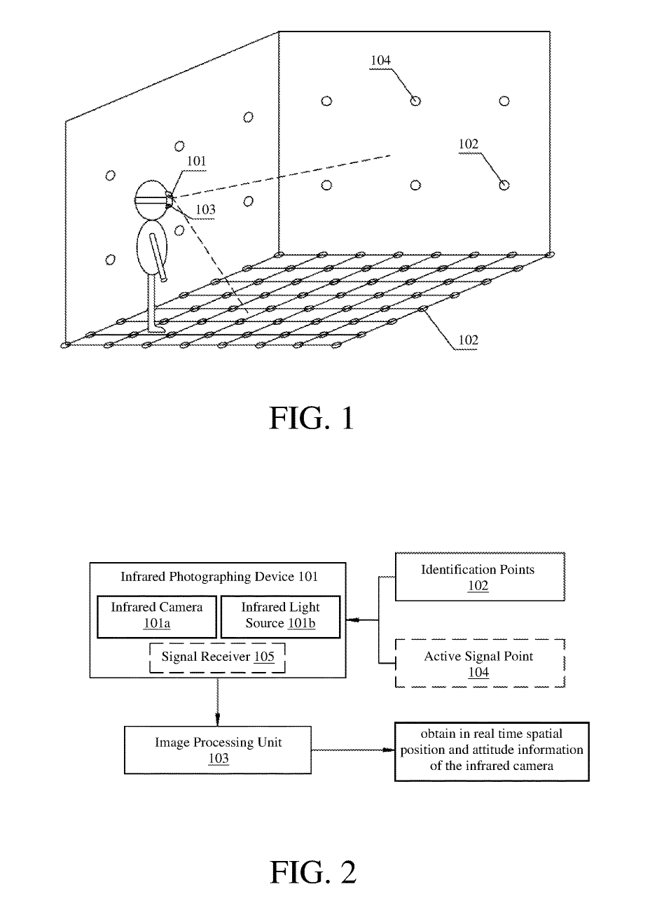

FIG. 1 and FIG. 2 respectively illustrate a schematic application diagram and a system block diagram of a visual positioning system based on highly infrared-reflective identification according to the present invention. The visual positioning system 100 of the present invention includes an infrared photographing device 101, a plurality of identification points 102, and an image processing unit 103.

The infrared photographing device 101 mainly includes an infrared camera 101a and an infrared light source 101b. The infrared light source 101b is configured to emit infrared light. The irradiation range of the infrared light should cover the shooting area of the infrared camera 101a. The infrared camera 101a is preferably a wide-angle camera, and is configured to continuously shoot a reflective photograph of the plurality of identification points 102, and transmit the shot photograph to the image processing unit 103. The number of the infrared cameras 101a is at least one, and preferably, is one or two.

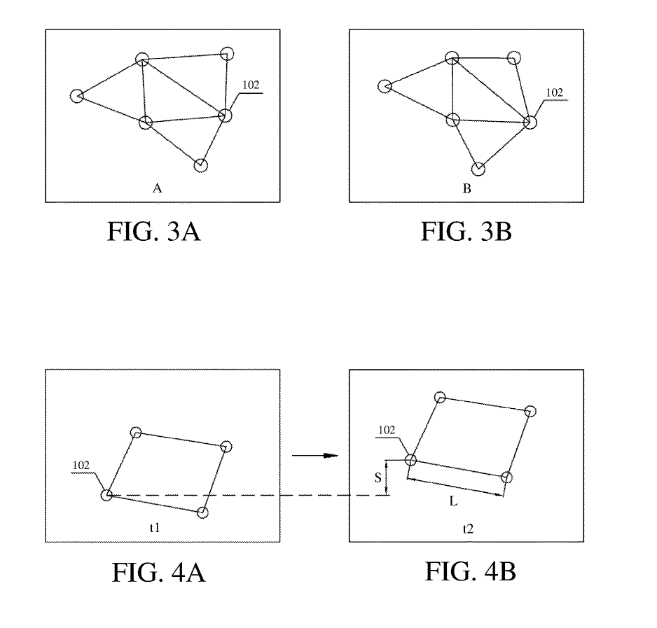

The plurality of identification points 102 is made of a highly infrared-reflective material, for example, a metal powder (having a reflective index of up to 80-90%). The identification point is generally fabricated into an adhesive or meltable sheet structure, and is adhered or melted at a placed to be visually positioned, to reflect the infrared light emitted from the infrared light source 101b, so as to be captured by the infrared camera 101a during shooting and displayed as a plurality of light spots in the image. According to an embodiment of the present invention, the plurality of identification points 102 is arranged in a positioning space to form a mesh with equal intervals, for example, a square mesh or regular-triangle mesh with equal intervals (as shown in FIG. 3A and FIG. 3B). The identification point 102 is a passive signal point, that is, the identification point 102 itself does not have specific coordinate information. When used for indoor positioning, the identification point 102 may be adhered on a floor or wall surface indoor, or integrated with the floor or wall surface, for example, adhered or integrated at intersections of four sides of each piece of floorboard or directly embedded in the floor surface; when used for outdoor positioning, the identification point 102 may be laid on a road outside or integrated with a zebra crossing on the road, or laid at other places that need to be positioned.

The image processing unit 103 is configured to analyze reflective positions of the identification points 102 in the image shot by the infrared camera 101a, to determine relative position and attitude information of the infrared camera 101a relative to the identification points 102 in the image. If the plurality of identification points 102 is arranged in a square mesh, the image shot by the infrared camera 101a should include at least four identification points 102 that are not on a same straight line, and the image processing unit 103 further obtains the positional relationship between the identification points 102, to implement positioning. Similarly, if the plurality of identification points 102 is arranged in a right-triangle mesh, the image shot by the infrared camera 101a should include at least three identification points 102 that are not on a same straight line. If there are redundant position identification points 102, the redundant position identification points 102 may be used for checking the accuracy of positioning, thereby improving the precision of visual positioning.

Lines connecting the plurality of identification points 102 in the image shot by the infrared camera 101a form a multi-family triangle or quadrilateral, as shown in FIG. 3A and FIG. 3B. The image processing unit 103 can determine the relative position and attitude information of the infrared camera 101a by analyzing a positional relationship (for example, angle, side length and area) of one of family triangles or quadrilaterals. For example, if the quadrilateral is a square, it indicates that the infrared camera 101a exactly faces the plane in which the identification points 102 are located; if the quadrilateral is not a square, it indicates that a shooting angle exists between the infrared camera 101a and the plane in which the identification points 102 are located, and the image processing unit 103 further processes the image to obtain the side length, angle or area of the quadrilateral, so as to calculate continuous positional relationship and attitude information of the infrared camera 101a relative to the identification points 102. According to the above content, a method for determining a relative displacement and attitude of the moving target can be obtained. The moving target moves in an environment where a plurality of passive infrared identification points 102 is disposed, and the moving target is equipped with an infrared camera 101a configured to photograph the infrared identification points 102 under irradiation of an infrared light source 101b. The method includes the following steps:

a) shooting, by the infrared camera 101a equipped in the moving target, a first image A including the infrared identification points 102, and recording a first shooting time;

b) determining whether a number of infrared identification points 102 in the first image is at least three and the infrared identification points are not on a same straight line; if yes, selecting one or more groups of at least three points that are not on a same straight line and constructing a first family polygon, and performing step c); otherwise, returning to the step a);

c) after a first time interval, shooting, by the infrared camera 101a equipped in the moving target, a second image B including the infrared identification points 102, and recording a second shooting time;

d) determining whether a number of infrared identification points 102 in the second image B is at least three and the infrared identification points are not on a same straight line; if yes, selecting one or more groups of at least three points that are not on a same straight line and constructing a first family polygon, and performing step e); otherwise, returning to the step c); and

e) calculating a relative displacement and/or shape change between the first family polygon and the second family polygon, and obtaining a relative displacement and attitude of the moving target at the second shooting time relative to the first shooting time.

In addition, assuming that the identification points 102 are laid at intersections of four sides of a floor tile and a commonly seen floor tile generally has a dimension of 30×30 cm, 60×60 cm, 100×100 cm or the like, the relative position change and attitude information of the infrared camera 101a are determined according to the dimension of the floor tile, connecting lines of the points 102 in the shot image, and a quadrilateral shape formed by the connecting lines.

If the dimension of the floor tile laid is known, the relative position change of the infrared camera 101a can be calculated by transformation according to positions of the identification points 102 in two consecutive images.

If the dimension of the floor tile laid is not known, the dimension of the floor tile laid needs to be determined first. Specifically, because the specification of the floor tile varies greatly, the dimension of the floor tile can be derived according to a ratio of a known height between the infrared camera 101a and the floor tile to a maximum distance between neighboring identification points 102 in the shot image. Alternatively, the dimension of the floor tile may be determined according to a ratio of a distance of movement of the infrared camera 101a within a time between neighboring moments t1 and t2 to a position change of the identification point 102 in the image, where the distance of movement of the infrared camera 101a may be determined according to the movement speed of the infrared camera 101a. As shown in FIG. 4A and FIG. 4B, the position change S of the identification point 102 may be calculated according to the distance of movement of the infrared camera 101a, and further a distance L between any two identification points 102 in the image may be obtained, so that the dimension of the floor tile can be derived.

In this way, the image processing unit 103 may determine the specification of the floor tile laid according to the movement speed and the shooting frequency of the infrared camera 101a. For example, the image processing unit 103 may obtain the specification of the floor tile according to the position change of the identification point 102 in two consecutive images and the movement speed and shooting frequency of the infrared camera 101a.

The visual positioning system based on highly infrared-reflective identification of the present invention can be applied to a wide range of fields such as intelligent robots, head-mounted display devices, blind guiding and navigation. When used in a head-mounted display device, the visual positioning system of the present invention is generally integrated with the head-mounted display device. After a user wears the head-mounted display device integrated with the visual positioning system of the present invention, relative position and attitude information of the user can be determined.

Because the identification points 102 of the present invention are passive identification points 102, only the relative position can be determined. Therefore, according to another embodiment of the present invention, the present invention may further include a plurality of active signal points 104 and a signal receiver 105. Each active signal point 104 has absolute coordinate information and actively sends a coordinate signal. The signal receiver 105 in the infrared photographing device 101 may receive the signal, so as to implement absolute positioning thereof. The active signal point 104 is used for performing absolute positioning in a large range, and the passive identification points 102 are used for performing precise relative positioning in a small local range and obtaining attitude information (for example, indoor positioning). Quick precise positioning can be achieved by combining absolute positioning in a large range with relative positioning in a small range.

It is not necessary to provide a large number of active signal points 104 as long as the infrared photographing device 101 or the head-mounted display device can receive signals sent from the active signal points 104. The active signal point 104 is generally disposed at the top edge of a building or on an advertising board. A user may wear a head-mounted display device integrated with the visual positioning system of the present invention to enter a virtual environment, and by using the active signal points 104 and the plurality of identification points 102 to perform precise positioning, virtual reality can be achieved.

Based on the above, the visual positioning system based on highly infrared-reflective identification of the present invention can implement relative positioning in a small range and absolute positioning in a large range, and also can obtain attitude information of the user. Particularly, the passive identification points 102 made of a highly infrared-reflective material have the advantages of simple structure, no need for a power supply, convenience in use, low costs, no delay and high positioning precision, etc.

The accompanying drawings are merely schematic and are not drawn to scale. It should be understood that although the present invention has been described with reference to preferred embodiments, the scope of protection of the present invention is not limited to the embodiments described herein.

Based on the description and practice of the present invention as disclosed herein, other embodiments of the present invention are readily conceived of and understood to those skilled in the art. The description and embodiments are provided for exemplary purpose only. The real scope and spirit of the present invention are defined by the claims.

What is claimed is:

1. A visual positioning system based on highly infrared-reflective identification, comprising a plurality of identification points, an infrared photographing device, and an image processing unit, wherein
the plurality of identification points is passive identification points made of a highly infrared-reflective material, and the identification points are arranged at equal intervals on a plane that needs to be positioned;
the infrared photographing device comprises an infrared camera and an infrared light source and is configured to shoot a reflective image of the plurality of identification points, wherein an irradiation range of the infrared light source should cover a shooting area of the infrared camera; and
the image processing unit continuously obtains a positional relationship between at least three identification points that are not on a same straight line in an image shot by the infrared camera, and further compares a positional relationship between neighboring identification points to obtain continuous changes in a relative position and a relative attitude of the infrared camera.

2. The visual positioning system according to claim 1, wherein the plurality of identification points is made of a metal powder.

3. The visual positioning system according to claim 2, wherein the plurality of identification points is each an adhesive or meltable sheet structure.

4. The visual positioning system according to claim 1, wherein the plurality of identification points is each an adhesive or meltable sheet structure.

5. The visual positioning system according to claim 1, wherein the infrared camera is a wide-angle camera.

6. The visual positioning system according to claim 5, wherein the number of the infrared cameras is one or two.

7. The visual positioning system according to claim 1, wherein the number of the infrared cameras is one or two.

8. The visual positioning system according to claim 1, wherein the plurality of identification points is laid at intersections of four sides of a floor tile.

9. The visual positioning system according to claim 8, wherein a dimension of the floor tile is calculated by the image processing unit according to a shooting height and a movement speed of the infrared camera.

10. The visual positioning system according to claim 1, wherein the positional relationship between the identification points comprises a distance between the identification points, an angle between lines connecting the identification points, and an area surrounded by the lines.

11. The visual positioning system according to claim 1, further comprising a plurality of active signal points and a signal receiver located in the infrared photographing device, wherein the signal receiver is configured to receive absolute positioning information sent from the active signal points.

12. A visual positioning method based on highly infrared-reflective identification, for determining a relative displacement and attitude of a moving target, wherein the moving target moves in an environment where a plurality of passive infrared identification points is disposed, and the moving target is equipped with an infrared camera configured to photograph the infrared identification points under irradiation of an infrared light source, the method comprising the following steps:
a) shooting, by the infrared camera equipped in the moving target, a first image comprising the infrared identification points, and recording a first shooting time;
b) determining whether a number of infrared identification points in the first image is at least three and the infrared identification points are not on a same straight line; if yes, selecting one or more groups of at least three points that are not on a same straight line and constructing a first family polygon, and performing step c); otherwise, returning to the step a);
c) after a first time interval, shooting, by the infrared camera equipped in the moving target, a second image comprising the infrared identification points, and recording a second shooting time;
d) determining whether a number of infrared identification points in the second image is at least three and the infrared identification points are not on a same straight line; if yes, selecting one or more groups of at least three points that are not on a same straight line and constructing a first family polygon, and performing step e); otherwise, returning to the step c); and
e) calculating a relative displacement and/or shape change between the first family polygon and the second family polygon, and obtaining a relative displacement and attitude of the moving target at the second shooting time relative to the first shooting time.
